(19) United States
(12) Patent Application Publication
(10) Pub. No.: US 2016/0192004 A1
(43) Pub. Date: Jun. 30, 2016

(54) METHOD, SYSTEM, AND RECORDING MEDIUM FOR MEASURING EFFECT OF PROVIDING INFORMATIONAL DATA

(71) Applicant: NAVER Corporation, Seongnam-si (KR)

(72) Inventor: Hyeon Su Jeong, Seongnam-si (KR)

(21) Appl. No.: 14/949,200

(22) Filed: Nov. 23, 2015

(30) Foreign Application Priority Data
Dec. 30, 2014 (KR) 10-2014-0193525

(51) Int. Cl. H04N 21/466; H04N 21/45; H04N 21/4784; H04N 21/442

(52) U.S. Cl. CPC H04N 21/4667; H04N 21/44222; H04N 21/4532; H04N 21/4524; H04N 21/4784

(57) ABSTRACT

Provided is a method, system, and non-transitory recording medium for analyzing the effect of providing informational data. An informational data effect analyzing method implemented in a computer to analyze, through a communication network, the effect of providing informational data that is provided through broadcast media, may include storing, by a processor of the computer, view history information about content corresponding to informational data that is viewed through the broadcast media with respect to the informational data that is provided to terminals of users of the broadcast media through the broadcast media, storing, by the processor, online action information about an online action taken on the Internet in association with the content, and analyzing, by the processor, the informational data effect based on a matching between the view history information and the online action information about the content.

### CROSS-REFERENCE TO RELATED APPLICATION

This application claims priority from and the benefit of Korean Patent Application No. 10-2014-0193525, filed on Dec. 30, 2014, the disclosure of which is incorporated herein in its entirety by reference.

### BACKGROUND

1. Field

Example embodiments of the present invention relate to technology for analyzing the effect of informational data provided using a variety of media.

2. Description of the Background

With the developments of communication technologies and various media, broadcasting and communication industry using television (TV) has been quickly developed. With such developments of the broadcasting and communication industry, technology for analyzing audience ratings and the effect of content, for example, content corresponding to informational data provided from a content provider, is also in development. Audience ratings are used to evaluate the broadcasting efficiency and a broadcasting company verifies the satisfaction of audiences about broadcasting based on the audience ratings. In particular, a content provider that provides informational data by paying a broadcasting company a large amount of money is susceptible to audience ratings and the effect of providing informational data, for example, a content display effect.

In recent times, analyzing TV ratings and the effect of providing informational data is generally conducted by two research institutions, AGB Nielsen Media Research and TNms Multimedia, with respect to exposed-type media such as broadcast media, for example, terrestrial TV and cable TV. The two research institutions conduct a search by selecting a sample group for survey of audience ratings and by installing a people meter to the sample group.

An audience ratings survey method using a people meter selects a sample group having a representative characteristic of a population through uniform distribution for each region, age, gender, and educational background, and gathers view pattern information about content and a broadcast program provided to the sample group using the people meter. Further, the audience ratings survey method performs a process of transferring data collected through the people meter to an effect analyzing server, and analyzing and reporting the result of monitoring an actual display of the broadcast program and the content and the effect thereof.

Currently, many companies are providing contents through TVs at large expenses. However, due to the difficulty in spontaneous effect analysis, the effect of providing informational data for display content may be analyzed based on priori information such as audience ratings. After-reactions of audiences may not be tracked and an indirect effect such as a brand image promotion may not be readily analyzed.

### SUMMARY

Some example embodiments of the present invention provide a method, system, and/or non-transitory computer-readable medium that analyze the effect of informational data (hereinafter, also referred to as an informational data effect) or content corresponding to the informational data provided to audiences through broadcast media by matching the broadcast media, such as television (TV), the TV audience, and the online actions of the TV audience.

Some example embodiments provide a method, system, and/or non-transitory computer-readable medium that analyze spontaneous reactions of audiences to informational data or content corresponding to the informational data provided to the audiences through broadcast media and provide information about the indirect influence of the informational data or the content.

According to at least one example embodiment, there is provided an informational data effect analyzing method configured as a computer to analyze, through a communication network, the effect of providing informational data that is provided through broadcast media, the method including storing, by a processor of the computer, view history information about content corresponding to informational data that is viewed through the broadcast media with respect to the informational data that is provided to terminals of users of the broadcast media through the broadcast media, storing, by the processor, online action information about an online action taken on the Internet in association with the content, and analyzing, by the processor, the informational data effect based on a match between the view history information and the online action information about the content.

The view history information may include local information about a region in which the content is viewed, and the analyzing of the informational data effect may include determining whether a location of a terminal having taken an online action associated with the content matches the local information.

The storing of the view history information may include storing information about a member of a household using the broadcast media, and the analyzing of the informational data effect may include determining whether a user having taken an online action associated with the content is the member.

The storing of the view history information may include storing an effect measurement time set to the informational data, and the analyzing of the informational data effect may include determining whether an online action associated with the content is taken within the effect measurement time after broadcasting the content in response to providing the informational data.

The analyzing of the informational data effect may include determining whether content associated with an online action taken on the Internet is content actually viewed using the broadcast media, based on the view history information.

The view history information may include network connection information used at the broadcast media to view the content, and the analyzing of the informational data effect may include determining whether network connection information of a terminal having taken an online action associated with the content matches the network connection information used at the broadcast media.

The storing of the view history information may include storing local information about a region in which the content is viewed, and storing an effect measurement time set to the informational data. The analyzing of the informational data effect may include determining whether a location of a terminal having taken an online action associated with the content matches the local information and whether the online action associated with the content is taken within the effect measurement time after broadcasting the content.

The storing of the view history information may includes storing information about a member of a household using the broadcast media, and the analyzing of the informational data effect may include determining whether a user having taken the online action associated with the content is the member in response to a match between the location of the terminal having taken the online action associated with the content and the local information.

The informational data effect analyzing method may further include providing a result of analyzing the informational data effect to a provider associated with the informational data.

The providing of the result may include providing statistical information of an online action associated with the content that matches the view history information.

The informational data effect analyzing method may further include providing reward information to a user that allows the view history information and the online action information to be public for analyzing the informational data effect.

According to at least one example embodiment, there is provided a non-transitory computer-readable recording medium including an instruction to control a computer system to analyze, through a communication network, the effect of providing informational data that is provided through broadcast media, wherein the instruction controls the computer system by a method including storing view history information about content corresponding to informational data that is viewed through the broadcast media with respect to the informational data that is provided to terminals of users of the broadcast media through the broadcast media, storing online action information about an online action taken on the Internet in association with the content, and analyzing the informational data effect based on a match between the view history information and the online action information about the content.

According to at least one example embodiment, there is provided an informational data effect analyzing system to analyze, through a communication network, an effect about providing informational data that is provided through broadcast media, the system including at least one processor, wherein the at least one processor includes a manager configured to manage view history information about content corresponding to informational data that is viewed through the broadcast media with respect to the informational data that is provided to terminals of users of the broadcast media through the broadcast media and online action information about an online action taken on the Internet in association with the content, and an analyzer configured to analyze the informational data effect based on a matching between the view history information and the online action information about the content. The view history information may include local information about a region in which the content is viewed, and the analyzer may be further configured to determine whether a location of a terminal having taken an online action associated with the content matches the local information.

The manager may be further configured to manage information about a member of a household using the broadcast media, and the analyzer may be further configured to determine whether a user having taken an online action associated with the content is the member.

The manager may be further configured to manage an effect measurement time set to the informational data, and the analyzer may be further configured to determine whether an online action associated with the content is taken within the effect measurement time after broadcasting the content in response to providing the informational data.

The analyzer may be further configured to determine whether content associated with an online action taken on the Internet is content actually viewed using the broadcast media, based on the view history information.

The view history information may include network connection information used at the broadcast media to view the content, and the analyzer may be further configured to determine whether network connection information of a terminal having taken an online action associated with the content matches the network connection information used at the broadcast media.

The at least one processor may further include a provider configured to provide a provider associated with the informational data with statistical information of an online action associated with the content that matches the view history information.

The informational data effect analyzing system may further include a provider configured to provide reward information to a user that allows the view history information and the online action information to be public for analyzing the informational data effect.

It is to be understood that both the foregoing general description and the following detailed description are explanatory and are intended to provide further explanation of the example embodiments as claimed.

According to at least one example embodiment, it is possible to activate cross-media content by matching broadcast media such as television (TV), the audience of the broadcast media, and online actions of the audience, and by utilizing the same as a new effect analyzing index for informational data provided to audiences through the broadcast media.

According to at least one example embodiment, by analyzing a spontaneous reaction of an audience to informational data provided to the audience through broadcast media, such as TV, based on an online action of the audience, it is possible to further actively analyze the effect of the provided informational data and to further improve the effect of providing informational data of a content provider.

### BRIEF DESCRIPTION OF THE DRAWINGS

The foregoing and other features of the example embodiments of the present invention will be apparent from the more particular description of non-limiting embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating an example of an environment for analyzing an informational data effect according to one exemplary embodiment.

FIG. 2 is a block diagram illustrating a configuration of an informational data effect analyzing system according to one exemplary embodiment.

FIG. 3 is a flowchart illustrating an informational data effect analyzing method according to one exemplary embodiment.

FIG. 4 illustrates an example of analyzing an informational data effect and providing the analysis result according to one exemplary embodiment.

FIG. 5 illustrates an example of an informational data effect analyzing scenario according to one exemplary embodiment.

FIG. 6 is a block diagram illustrating a configuration of a computer system according to at least one exemplary embodiment.

### DETAILED DESCRIPTION

Example embodiments of the present invention will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions may be exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, example embodiments of the present invention will be described with reference to the accompanying drawings.

The example embodiments relate to technology for analyzing a reaction of an audience to informational data provided through broadcast media such as television (TV), and more particularly, to a method, system, and non-transitory recording medium that analyze a spontaneous reaction of an audience to informational data provided through broadcast media by matching between viewing of the provided informational data and an online action associated with content corresponding to the informational data.

The broadcast media is not limited to TV and may be expanded to example embodiments that analyze the effect of informational data provided through various media, for example, radio, online (Internet), and offline. The terms “effect of providing informational data” and “informational data effect” may be interchangeably used throughout. Further, the terms “audience” and “user” may be interchangeably used throughout.

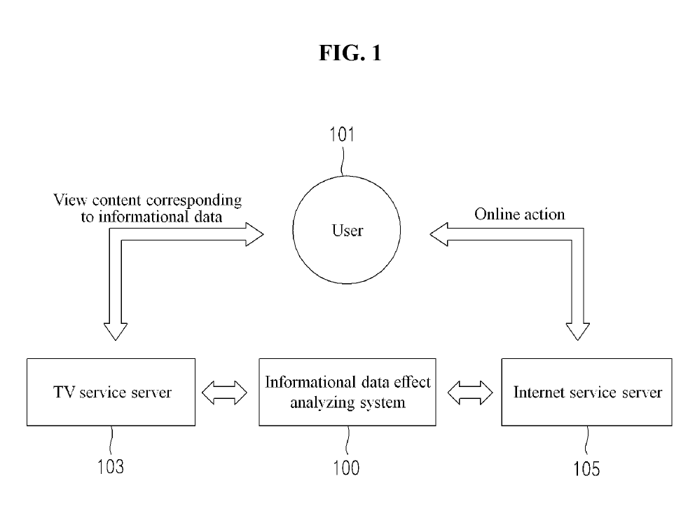

FIG. 1 is a diagram illustrating an example of an environment for analyzing an informational data effect according to one exemplary embodiment. FIG. 1 illustrates a user 101, a TV service server 103, an Internet service server 105, and an informational data effect analyzing system 100. In this instance, the user 101 may refer to a terminal substantially used by the user 101. In FIG. 1, indicators with arrowheads may indicate that data may be transmitted and received between constituent elements of FIG. 1 over a wired/wireless network.

The user 101 refers to an entity that views content corresponding to informational data and creates an informational data effect in reaction to the content. The user 101 may search for Internet information about the content viewed by the user 101. Here, the terminal used for the information search may be the same as or different from the terminal used by the user 101 to view the content. For example, the user 101 may view content and conduct an Internet search using an Internet TV, however, may not conduct an Internet search using a TV such as a general airwave receiver. Thus, when the user 101 is to conduct an Internet search for content viewed on a TV, the user 101 uses a separate terminal capable of performing Internet communication.

In the present specification, the term “TV” may indicate broadcast media, for example, a general airwave receiver, an Internet TV, and a digital multimedia broadcasting (DMB), which serve as media that output or display content corresponding to informational data. Also, a terminal used for an Internet search may be any type of terminal devices that perform Internet communication, for example, an Internet TV, a personal computer (PC), a laptop computer, a smartphone, a tablet, and a wearable computer.

The TV service server 103 serves as a platform that provides a TV service to a client, for example, the user 101, and may include, for example, a content provider (CP) that provides a broadcast program and content corresponding to informational data and a people meter that surveys TV ratings. In particular, the TV service server 103 may provide information that may be used to analyze the effect of informational data provided through broadcast media, for example, information about content corresponding to the informational data and information about viewing of content for each audience.

The Internet service server 105 serves as a platform that provides Internet service to the user 101, and may include, for example, a search engine that enables the user 101 to conduct an information search on the Internet, an online market that provides an application download service, a free call that provides Internet call service over a data network, and an online shopping mall that sells products. In particular, the Internet service server 105 collects and provides information about user action taken on the Internet, for example, an information search, an application installation, an outgoing call, a visitation to a site, a member signup, a product purchase, a counseling request, and a participation in an event, as an online action taken on the Internet in association with content corresponding to informational data, through a terminal such as a PC or a mobile computing device or a mobile phone.

The informational data effect analyzing system 100 serves to analyze the reaction of the user 101, for example, an audience, to informational data, for example, content corresponding to the informational data, provided from the TV service server 103, and to analyze the informational data effect by matching viewing of the informational data and an online action of the audience. That is, the informational data effect analyzing system 100 is employed to measure the informational data effect by tracking an after-reaction of the user 101, for example, the audience to content corresponding to informational data viewed by the user 101 in interaction with the TV service server 103 and the Internet service server 105.

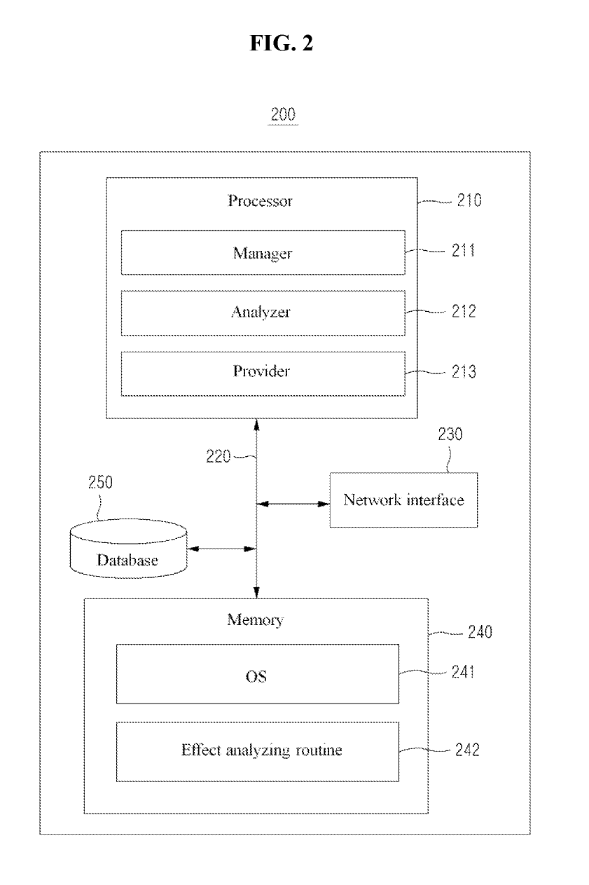

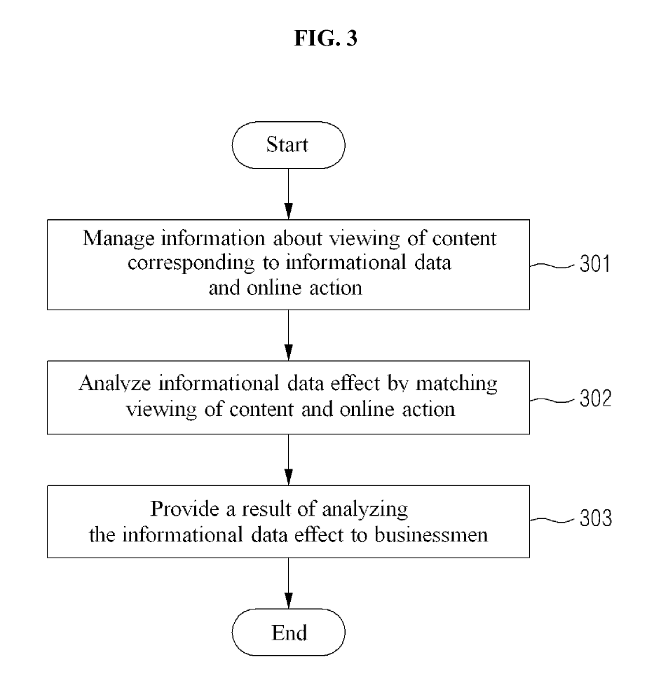

FIG. 2 is a block diagram illustrating a configuration of the informational data effect analyzing system 100 according to one exemplary embodiment, and FIG. 3 is a flowchart of an informational data effect analysis performed by the informational data effect analyzing system 100.

Referring to FIG. 2, the informational data effect analyzing system 100 includes a processor 210, a bus 220, a network interface 230, a memory 240, and a database 250. The memory 240 includes an operating system (OS) 241 and an effect analyzing routine 242. The processor 210 includes a manager 211, an analyzer 212, and a provider 213. According to other example embodiments, the informational data effect analyzing system 100 may include more number of constituent elements than the number of constituent elements of FIG. 2.

The memory 240 includes a permanent mass storage device, such as a random access memory (RAM), a read only memory (ROM), or a disc drive, as a computer-readable storage medium. Also, program codes for the OS 241 and the effect analyzing routine 242, and the like, may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, and a memory card. Software constituent elements may be loaded to the memory 240 through the network interface 230 instead of using the computer-readable storage medium. According to other example embodiments, software constituent elements may be loaded to the memory 240 through the network interface 230 instead of computer-readable storage media.

The bus 220 enables communication and data transmission between the constituent elements of the informational data effect analyzing system 100. The bus 220 may be configured using a high-speed serial bus, a parallel bus, a storage area network (SAN), and/or another appropriate communication technology.

The network interface 230 is a computer hardware constituent element for connecting the informational data effect analyzing system 200 to the computer network. The network interface 230 may connect the informational data effect analyzing system 200 to the computer network through a wireless or wired connection.

The database 250 serves to store and maintain information required to analyze the informational data effect. For example, the database 250 may include information provided from the TV service server 103 and the Internet service server 105 of FIG. 1, as information for tracking online actions and viewing of content, for example, content corresponding to informational data by audiences. Also, the database 250 may include information registered directly by the user through a separate path, for example, a website/mobile site or a service exclusive application. Although FIG. 2 illustrates that the database 250 is included in the informational data effect analyzing system 100, the database 250 may be present as an external database constructed in another system. For example, an information DB constructed on an external platform interactive with the informational data effect analyzing system 100 may be used as the database 250.

The processor 210 is configured to process computer-readable instructions of a computer program by performing basic calculations, logic, and input/output operations of the informational data effect analyzing system 100. The computer-readable instructions may be provided from the memory 240 or the network interface 230 to the processor 210 through the bus 220. The manager 211, the analyzer 212, and the provider 213 included in the processor 210 are configured to execute program codes loaded to the memory 240, so that operations 301 through 303 of FIG. 3 may be performed. The program codes may be loaded from a program file to a storage device such as the memory 240. The manager 211, the analyzer 212, and the provider 213 are representations of different functions performed by the processor 210. For example, the processor 210 is configured to execute operation 301 of the program codes as the manager 211.

In operation 301, the manager 211 manages information about viewing of content corresponding to informational data and an online action. For example, the manager 211 may register and manage information about viewing of content and an online action of an audience to track an after-reaction of the audience to the content.

The manager 211 registers broadcast information of content displayed on a TV. Here, the broadcast information may include a type of content corresponding to informational data, a type of media through which the content is displayed, a content broadcast time, for example, a start time and an end time of content, and a setting time for measuring the informational data effect. The manager 211 may receive and register broadcast information from a TV service server, or may directly receive and register broadcast information from a server of a content provider that provides informational data.

The manager 211 manages audience information associated with each TV as information of an individual audience capable of viewing content. Here, the audience information may include a type of a TV used by the audience, individual audience information, service area information, and a viewing environment. The manager 211 may register a variety of information such as a type of a TV that is broadcast media, for example, a general airwave receiver, an Internet TV, and a DMB. The variety of information may include identification information, for example, a serial number and an identifier (ID), for identifying a corresponding TV. In an environment in which a plurality of audiences is using the registered TV, an individual member using the TV may be registered. For example, the manager 211 may manage an individual member by registering a telephone number or an ID of each member as an individual key. Also, the manager 211 may register a region or a place in which each individual member may view a TV, for each individual member. Further, as a viewing environment, the manager 211 may register a usage environment and other information, for example, a wireless fidelity (WiFi) using the TV, a beacon, and a people meter. The audience information may be provided from the TV service server 103, or may be directly input from an audience through a website/mobile site or a service exclusive application.

The manager 211 manages content viewing information of an audience to verify whether the audience has viewed the content. For example, the manager 211 may register information about content viewed by the audience through an Internet TV and content information collected through a people meter. For example, the manager 211 may receive and register a list of contents viewed by the audience from the TV service server 103 or a server of the people meter.

The manager 211 manages an online action of an audience taken on the Internet. Here, the online action refers to the behavior of an audience performed due to displaying of content corresponding to informational data, and may indicate any type of behaviors connectable to the informational data effect with respect to the corresponding content. For example, the manager 211 may collect online action information regarding a search query, a click, a site visitation, a member signup, a product purchase, a counseling request, a participation in an event, an outgoing call, and an App installation that are performed by an audience in interaction with the Internet service server 105. The content provider may predict and register in advance, for example, a keyword, site information, a telephone number, and App installation and execution information, which may be used by the audience having viewed content as an after-action to the content. Based on the registered information, the manager 211 collects online actions of the audience. Further, the manager 211 collects log information associated with the online actions from the Internet service server 105. The log information may include network connection information or location information of a terminal used by the audience to connect to the Internet. For example, the network connection information or location information of the terminal may include information about WiFi, a global positioning system (GPS), and a base station.

In operation 302, the analyzer 212 analyzes the informational data effect by matching viewing of the content and the online action of the audience.

For example, the analyzer 212 may determine whether the audience has viewed the content based on content viewing information. That is, the analyzer 212 may verify whether a TV was turned ON at a corresponding household of the audience and the content was viewed based on content viewing information provided from the TV service server 103 or the server of the people meter.

As another example, the analyzer 212 may determine whether a TV viewing region stored in advance as audience information matches the location at which the online action was taken through comparison therebetween. The location at which the online action was taken may indicate the terminal location estimated using, for example, WiFi, a GPS, and a base station, as location information of the terminal used by the audience, and may be used to verify whether the online action of the user has occurred in the TV viewing region and whether the online action of the user is related to actual TV viewing.

As another example, the analyzer 212 may verify whether a user who has taken an online action associated with content is a member of a household to which the content is broadcasted. Accordingly, instead of regarding all of the online actions having occurred in the TV viewing region as the informational data effect, only an online action taken by a member of a household having actually viewed the content may be regarded as the informational data effect.

As another example, the analyzer 212 may determine whether online action information of an audience has occurred within a preset effect measurement time after broadcasting the content, based on broadcast information of the content. Here, the effect measurement time may be set by the content provider based on a type or characteristic of the content. The effect measurement time may be set as a time at which the content provider is to measure the indirect effect about the content to be suitable for the effect desired by the content provider. That is, an online action having occurred within the effect measurement time after broadcasting the content may be determined to be valid and be collected as the informational data effect.

As another example, the analyzer 212 may determine whether network environment information, for example, WiFi environment information, stored in advance as audience information is commonly used for viewing of content and online connection. That is, the analyzer 212 may verify whether the network environment in the case of viewing a TV matches the network environment in the case of the online connection.

The analyzer 212 verifies information that may be regarded as an after-action of the audience based on a matching relationship between viewing of the content and the online action, and collects and stores the verified information as the informational data effect.

The analyzer 212 may also apply a priority order to be used as an effect analyzing index with respect to a matching relationship between viewing of content and an online action. The analyzer 212 may preferentially match the region and the time between viewing of the content and the online action. For example, the analyzer 212 may apply a weight to a factor such as whether an online action of a user is an action having occurred in a region in which content is viewed, whether the user having taken the online action is a member of a household having viewed the content, and whether the online action of the user has occurred within an effect measurement time set by a content provider.

Also, the analyzer 212 may analyze the informational data effect by combining at least two factors among a plurality of factors capable of verifying the matching relationship between viewing of the content and the online action. For example, the analyzer 212 may verify whether an online action of a user has occurred in a content viewing region within an effect measurement time set by a content provider by combining a region and a time between viewing of the content and the online action. Here, when the online action of the user matches the content viewing region, an additional factor of verifying whether the user having taken the online action is the member of the household having viewed the content may be further combined.

In operation 303, the provider 213 outputs or provides a result of analyzing the informational data effect. The provider 213 may provide information verified by the analyzer 212 as the informational data effect to interested parties such as a content provider, an agency, media, and a media representative (Rep). The agency and media representative may be service providers for creating, planning, and/or handling the content of the content provider between the content provider and the media. The media may be a broadcast media such as television (TV).

Here, the provider 213 may provide information of the online action that matches viewing of the content, and may provide information for each factor used as an effect analyzing index when providing the result of analyzing the informational data effect. For example, the provider 213 may provide information about a search change of a keyword, for example, a company and a brand name, associated with an after-action of an audience after broadcasting the content. As another example, the provider 213 may provide information about a site visitation or an App installation by an after-action of an audience immediately after viewing content. As another example, the provider 213 may provide information about the number of incoming calls by an after-action of an audience immediately after viewing content. As another example, the provider 213 may provide information in which an amount of online actions of audiences is compared based on the presence and absence of the content.

Further, the provider 213 may provide a desired (or alternatively predetermined) reward as a method of expanding service users capable of participating in measuring the informational data effect. The provider 213 may expand and secure service subscribers by providing a variety of benefits, for example, a free TV viewing service, a content voucher, a coupon, and a mileage, to a user that participates in measuring the informational data effect, that is, a user that allows information about an online action and viewing of content corresponding to informational data to be public for the effect analysis. For example, the provider 213 may determine a service user participating in measuring the informational data effect and a reward predetermined according to participating in measuring the informational data effect. Then the predetermined reward may be provided to the determined service user online.

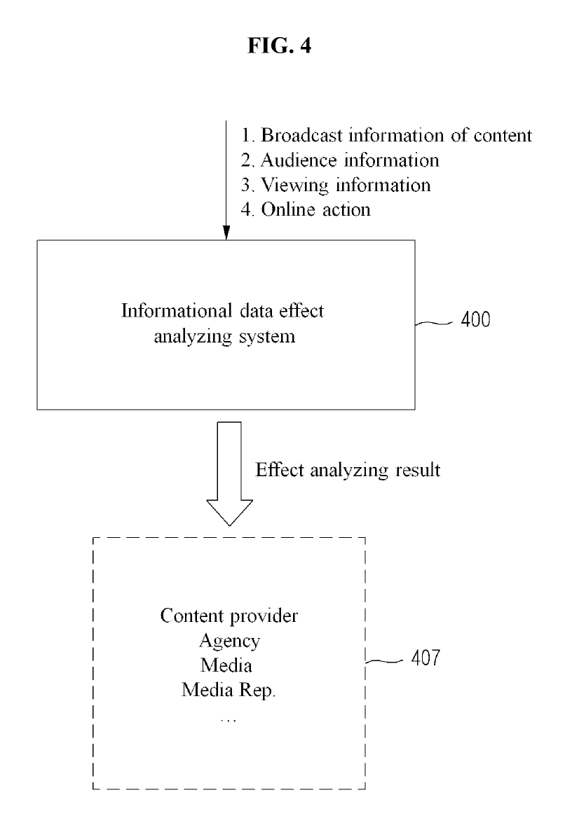

For example, referring to FIG. 4, the informational data effect analyzing system 100 may track an action taken on the Internet as a reaction of an audience to content. In particular, the informational data effect analyzing system 100 may collect content broadcast information, audience information of a TV, actual TV viewing information of an audience, and online action information using a PC or a mobile device, may verify whether an online action of the audience is related to viewing of the content, that is, whether the online action is triggered due to viewing of the content, and may provide an effect analyzing result to interested parties 407 to be used as content marketing of the parties 407, for example, a content provider, an agency, media, and a media Rep.

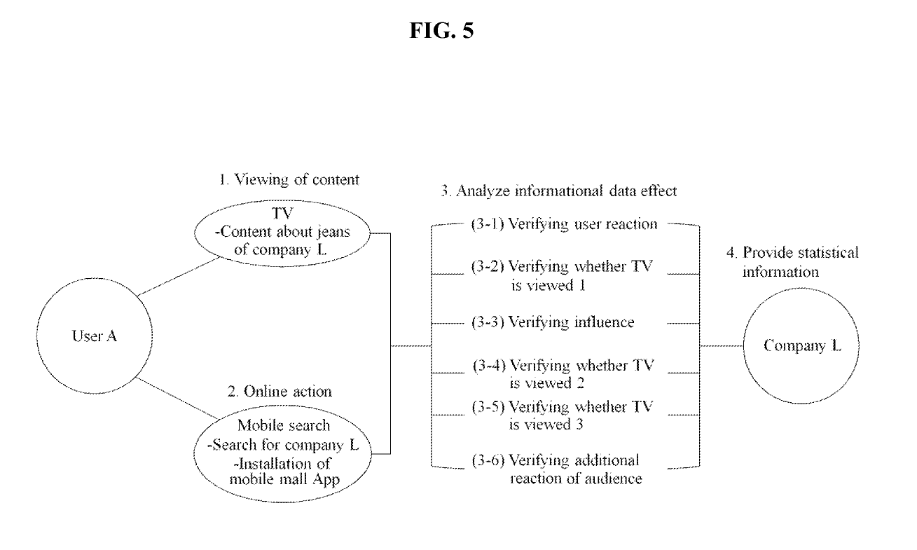

FIG. 5 illustrates an example of an informational data effect analyzing scenario according to one embodiment.

Hereinafter, an effect analyzing process will be described with reference to FIG. 5.

1. User A is a member of a family having joined an effect analyzing service views content about jeans of company L on a TV.

2. After viewing the content on the TV, user A searches for company L using a mobile device with the intent of purchasing the jeans and installs a shopping mall App. Here, a mobile search for company L and an installation of the shopping mall App are online actions of user A and represent after-actions of user A to the content about jeans of company L.

3. The content effect about jeans of company L may be analyzed based on a matching relationship between “1. viewing of the content” and “2. online action” of user A. Here, the content effect refers to an effect achieved by displaying content corresponding to informational data in response to providing the informational data.

(3-1) Verifying a user reaction: A search history of user A having joined an effect analyzing service and having searched for “company L” with a keyword registered in advance to company L that is a content provider through the mobile search App is verified.

(3-2) Verifying whether a TV is viewed 1: Whether a TV is ON at the house of user A and user A has actually viewed the content about jeans of company L is verified based on audience information registered by a TV service server or user A and viewing information provided from the TV service server or a server of a people meter.

(3-3) Verifying influence: Whether the content about jeans of company L was actually broadcasted on the TV before user A searched for “company L” is verified based on broadcast information provided from the TV service server.

(3-4) Verifying whether a TV is viewed 2: Whether WiFi information used for Internet connection when the user A searches for “company L” through the mobile search App matches WiFi being used at the TV for a TV service is verified.

(3-5) Verifying whether a TV is viewed 3: Whether terminal location information used for Internet connection when user A searches for “company L” through the mobile search App matches a TV viewing region registered in advance by user A is verified.

(3-6) Verifying an additional reaction of an audience: Other histories, for example, an additional click, a site visitation, a member signup, a counseling request, a participation in an event, an outgoing call, and an App installation, of user A on the Internet after search for company L through the mobile search App are verified.

4. The effect analyzing result of “3.” may be provided to company L that is a content provider of the content about jeans of company L broadcasted on the TV.

According to the example embodiments, it is possible to collect online actions having occurred as after-reactions of an audience to content and to analyze information about the influence of the content based on a relationship matching between viewing of the content and the online actions.

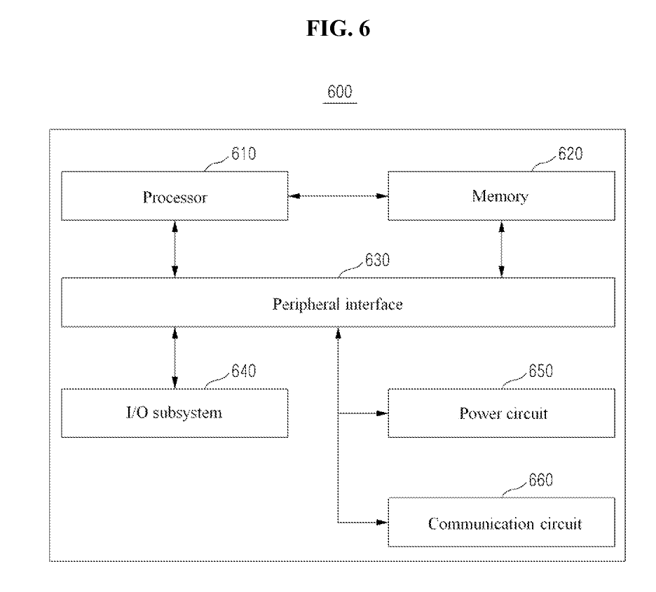

FIG. 6 is a block diagram illustrating an example of a configuration of a computer system according to some example embodiments. Referring to FIG. 6, the computer system 600 may correspond to the informational data effect analyzing system 100 in an example embodiment, and may include at least one processor 610, a memory 620, a peripheral interface 630, an input/output (I/O) subsystem 640, a power circuit 650, and a communication circuit 660. Here, the computer system 600 may correspond to a user terminal or a server system. For example, the at least one processor 610 may correspond to the processor 210 and the memory 620 may correspond to the memory 240.

The memory 620 may include, for example, a high-speed random access memory (HSRAM), a magnetic disk, a static random access memory (SRAM), a dynamic RAM (DRAM), read only memory (ROM), a flash memory, and a non-volatile memory. The memory 620 may include a software module, an instruction set, or a variety of data required for an operation of the computer system 600. Here, an access from another component such as the processor 610 and the peripheral interface 630 to the memory 620 may be controlled by the processor 610.

The peripheral interface 630 may couple an input device and/or output device of the computer system 600 with the processor 610 and the memory 620. The processor 610 may perform a variety of functions for the computer system 600 and process data by executing the software module or the instruction set stored in the memory 620.

The I/O subsystem 640 may couple various I/O peripheral devices with the peripheral interface 630. For example, the I/O subsystem 640 may include a controller for coupling the peripheral interface 630 and a peripheral device such as a monitor, a keyboard, a mouse, a printer, and a touch screen or a sensor depending on a necessity. The I/O peripheral devices may be coupled with the peripheral interface 630 without using the I/O subsystem 640.

The power circuit 650 may supply a power to all of or a portion of components of a terminal. For example, the power circuit 650 may include a power management system, at least one power source such as a battery and alternating circuit (AC), a charge system, a power failure detection circuit, a power converter or inverter, a power status indicator, or other components for creating, managing and distributing power.

The communication circuit 660 enables communication with another computer system using at least one external port. Alternatively, as described above, the communication circuit 660 may enable communication with another computer system by including a radio frequency (RF) circuit and thereby transmitting and receiving an RF signal known as an electromagnetic signal.

The example embodiments of FIG. 6 are only an example of the computer system 600. The computer system 600 may have a configuration or an arrangement for omitting a portion of the components illustrated in FIG. 6, further including components not illustrated in FIG. 6, or coupling two or more components. For example, a computer system for a communication terminal of a mobile environment may further include a touch screen, a sensor, and the like, in addition to the components of FIG. 6. A circuit for RF communication using a variety of communication methods, for example, WiFi, 3rd generation (3G), long term evolution (LTE), Bluetooth, near field communication (NFC), and ZigBee, may be included in the communication circuit 660. Components includable in the computer system 600 may be configured as hardware that includes an integrated circuit specified for at least one signal processing or application, software, or a combination of hardware and software.

The methods according to the example embodiments of the present invention may be configured in a program instruction form executable through various computer systems and thereby recorded in non-transitory computer-readable media.

A program according to the example embodiments may be configured as a PC-based program or an application exclusive for a mobile terminal.

As described above, according to some example embodiments, it is possible to activate cross-media content by matching broadcast media such as a TV, an audience of the broadcast media, and an online action of the audience, and by utilizing the same as a new effect analyzing index for informational data provided to audiences through the broadcast media. According to some example embodiments, by analyzing a spontaneous reaction of an audience to informational data provided to the audience through broadcast media, such as a TV, based on an online action of the audience, it is possible to further actively analyze an effect about the provided informational data and to further improve an effect about providing informational data of a content provider.

The systems and/or the devices, such as the informational data effect analyzing system 100, the computer system 600, and the terminal devices, described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. An informational data effect analyzing method, implemented in a computer to analyze, through a communication network, an effect of providing informational data through broadcast media, the method comprising:
storing, by a processor of the computer, view history information about content corresponding to informational data that is viewed through the broadcast media with respect to the informational data that is provided to terminals of users of the broadcast media through the broadcast media;
storing, by the processor, online action information about an online action taken on the Internet in association with the content; and
analyzing, by the processor, the informational data effect based on a match between the view history information and the online action information about the content.

2. The method of claim 1, wherein the view history information comprises local information about a region in which the content is viewed, and
the analyzing of the informational data effect comprises determining whether a location of a terminal having taken an online action associated with the content matches the local information.

3. The method of claim 1, wherein the storing of the view history information comprises storing information about a member of a household using the broadcast media, and
the analyzing of the informational data effect comprises determining whether a user having taken an online action associated with the content is the member.

4. The method of claim 1, wherein the storing of the view history information comprises storing an effect measurement time set to the informational data, and
the analyzing of the informational data effect comprises determining whether an online action associated with the content is taken within the effect measurement time after broadcasting the content in response to providing the informational data.

5. The method of claim 1, wherein the analyzing of the informational data effect comprises determining whether content associated with an online action taken on the Internet is content actually viewed using the broadcast media, based on the view history information.

6. The method of claim 1, wherein the view history information comprises network connection information used at the broadcast media to view the content, and
the analyzing of the informational data effect comprises determining whether network connection information of a terminal having taken an online action associated with the content matches the network connection information used at the broadcast media.

7. The method of claim 1, wherein the storing of the view history information comprises:
storing local information about a region in which the content is viewed; and
storing an effect measurement time set to the informational data, and
the analyzing of the informational data effect comprises determining whether a location of a terminal having taken an online action associated with the content matches the local information and whether the online action associated with the content is taken within the effect measurement time after broadcasting the content.

8. The method of claim 7, wherein the storing of the view history information comprises storing information about a member of a household using the broadcast media, and
the analyzing of the informational data effect comprises determining whether a user having taken the online action associated with the content is the member in response to a match between the location of the terminal having taken the online action associated with the content and the local information.

9. The method of claim 1, further comprising:
providing a result of analyzing the informational data effect to a party associated with the informational data.

10. The method of claim 9, wherein the providing of the result comprises providing information of an online action associated with the content that matches the view history information.

11. The method of claim 1, further comprising:
providing reward information to a user that allows the view history information and the online action information to be public for analyzing the informational data effect.

12. A non-transitory computer-readable recording medium storing instructions to control a computer system to analyze, through a communication network, an effect of providing informational data through broadcast media, wherein the instructions control the computer system to perform the steps comprising:
storing view history information about content corresponding to informational data that is viewed through the broadcast media with respect to the informational data that is provided to terminals of users of the broadcast media through the broadcast media;
storing online action information about an online action taken on the Internet in association with the content; and
analyzing the informational data effect based on a match between the view history information and the online action information about the content.

13. An informational data effect analyzing system to analyze, through a communication network, an effect of providing informational data through broadcast media, the system comprising:
at least one processor,
wherein the at least one processor comprises:
a manager configured to manage view history information about content corresponding to informational data that is viewed through the broadcast media with respect to the informational data that is provided to terminals of users of the broadcast media through the broadcast media and online action information about an online action taken on the Internet in association with the content; and
an analyzer configured to analyze the informational data effect based on a matching between the view history information and the online action information about the content.

14. The system of claim 13, wherein the view history information comprises local information about a region in which the content is viewed, and
the analyzer is further configured to determine whether a location of a terminal having taken an online action associated with the content matches the local information.

15. The system of claim 13, wherein the manager is further configured to manage information about a member of a household using the broadcast media, and
the analyzer is further configured to determine whether a user having taken an online action associated with the content is the member.

16. The system of claim 13, wherein the manager is further configured to manage an effect measurement time set to the informational data, and
the analyzer is further configured to determine whether an online action associated with the content is taken within the effect measurement time after broadcasting the content in response to providing the informational data.

17. The system of claim 13, wherein the analyzer is further configured to determine whether content associated with an online action taken on the Internet is content actually viewed using the broadcast media, based on the view history information.

18. The system of claim 13, wherein the view history information comprises network connection information used at the broadcast media to view the content, and
the analyzer is further configured to determine whether network connection information of a terminal having taken an online action associated with the content matches the network connection information used at the broadcast media.

19. The system of claim 13, wherein the at least one processor further comprises:
a provider configured to provide a party associated with the informational data with statistical information of an online action associated with the content that matches the view history information.

20. The system of claim 13, wherein
the provider is configured to provide reward information to a user that allows the view history information and the online action information to be public for analyzing the informational data effect.
